(19) United States
(12) Patent Application Publication
(10) Pub. No.: US 2004/0003900 A1
(43) Pub. Date: Jan. 8, 2004

(54) Venetian blind having lift cords kept from sight

(75) Inventor: Ming Nien, Changhua Hsien (TW)

Correspondence Address: BACON & THOMAS, PLLC, 625 SLATERS LANE, FOURTH FLOOR, ALEXANDRIA, VA, 22314

(73) Assignee: Nien Made Enterprise Co., Ltd., Changhua Hsien (TW)

(21) Appl. No.: 10/245,755

(22) Filed: Sep. 18, 2002

(30) Foreign Application Priority Data
Jul. 4, 2002 (TW) 91210306

(51) Int. Cl. E06B 9/30

(52) U.S. Cl. 160/168.1 R

(57) ABSTRACT

A lift Venetian blind lift using a lift lock to lock/unlock the lift cord, a receiving tube to receive the end of the lift cord and to keep the lift cord from sight and reach of children, and a swinging device to couple the receiving tube to the lift lock for enabling the receiving tube to be turned forwards/backwards and leftwards/rightwards relative to the headrail in two perpendicularly intersected directions to control locking/unlocking of the lift lock conveniently.

### BACKGROUND OF THE INVENTION

1. Field of the Invention

The present invention relates to Venetian blinds and, more specifically, to such a Venetian blind that keeps the lift cords from sight and reach of children.

2. Description of the Related Art

A regular Venetian blind is generally comprised of a top rail, a bottom rail, a plurality of slats arranged in parallel between the top rail and the bottom rail, a lift control mechanism for controlling lifting and positioning of the bottom rail to adjust the extending area of the Venetian blind, and a tilting control mechanism for controlling the tiling angle of the slats to regulate the light. The lift control mechanism comprises a lift cord suspended from the top rail at one side for operation by hand to control the elevation of the bottom rail. Because the lift cord is exposed to the outside, it destroys the sense of beauty of the Venetian blind. Further, because a child can easily reach the exposed lift cord, an accident may occur when a child pulling the lift cord for fun.

In order to eliminate the aforesaid problems, Venetian blinds with concealed lift cords are developed. There is known a commercially available Venetian blind with concealed lift cords, which comprises a receiving tube suspended from the headrail to hold the operating ends of the lift cords. The receiving tube keeps the lift cords from sight and reach of children. However, because the receiving tube is directly fastened to the headrail, it can only be tilted within a very limited angle. Because of limited tilting angle of the receiving tube, it is difficult to manipulate the lift cords as desired. Furthermore, the receiving tube cannot be adjusted to different elevations to fit different users. In general, this structure of Venetian blind is not orthopedically engineered for convenient use.

### SUMMARY OF THE INVENTION

The present invention has been accomplished to provide a Venetian blind, which eliminates the aforesaid drawbacks. It is the main object of the present invention to provide a Venetian blind having lift cords kept from sight, which is orthopedically engineered for convenient use.

It is another object of the present invention to provide a Venetian blind having lift cords kept from sight, which is simple and inexpensive to manufacture.

To achieve these objects of the present invention, the Venetian blind comprises a headrail extended in transverse direction, the headrail having a first end; a bottom rail extended in transverse direction and spaced below the headrail; a plurality of slats arranged in parallel between the headrail and the bottom rail; a receiving tube vertically suspended from the first end of the headrail; at least one lift cord, the at least one lift cord each having a first end fixedly fastened to the bottom rail and a second end upwardly extended through the slats into the inside of the headrail and then transversely extended to the first end of the headrail and then extended vertically downwards from the first end of the headrail into the inside of the receiving tube; a lift lock mounted inside the first end of the headrail and controlled by the receiving tube to lock/unlock the lift cords; and a swinging device coupled between the lift lock and the receiving tube for enabling the receiving tube to be turned back and forth in a predetermined direction relative to the headrail, the swinging device comprising a top hanging portion coupled to the headrail, and a bottom track portion pivoted to the receiving tube for enabling the receiving tube to be moved along the bottom track portion.

### BRIEF DESCRIPTION OF THE DRAWINGS

FIG. 1 is a schematic drawing of a first preferred embodiment of the present invention, showing the Venetian blind extended out.

FIG. 2 is a sectional view in an enlarged scale of a part of FIG. 1, showing the lift lock in the locking position.

FIG. 3 is similar to FIG. 2 but showing the receiving tube turned leftwards relative to the headrail, the lift cords disengaged from the lift lock.

FIG. 4 is a sectional view in an enlarged scale of a part of the first embodiment of the present invention, showing the receiving tube turned forwards relative to the headrail.

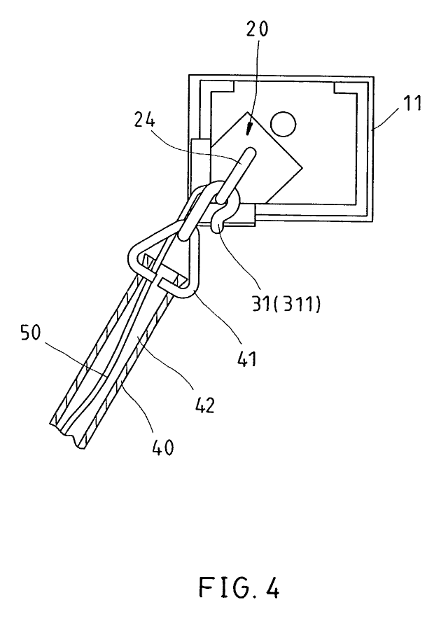

FIG. 5 is a sectional view of a part of a second preferred embodiment of the present invention, showing the lift lock in the locking position.

FIG. 6 is similar to FIG. 5 but showing the receiving tube turned leftwards, the lift cords disengaged from the lift lock.

FIG. 7 is similar to FIG. 5 but showing the receiving tube turned forwards relative to the headrail.

### DETAILED DESCRIPTION OF THE PREFERRED EMBODIMENT

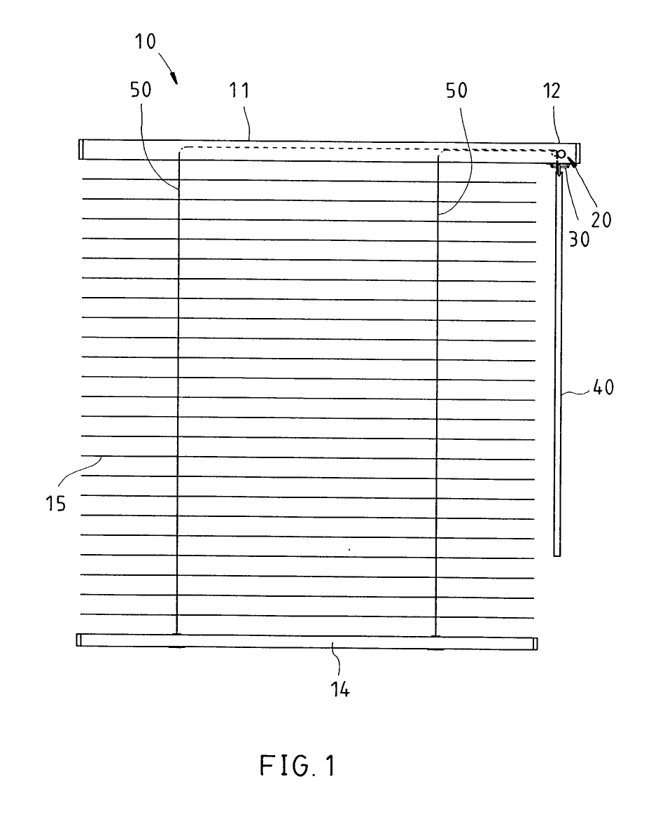

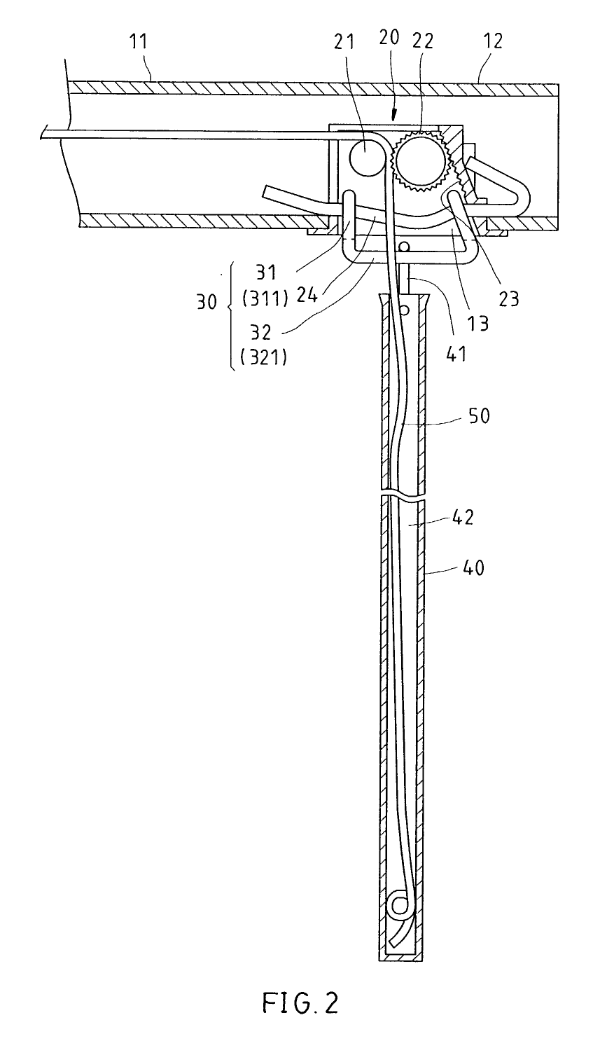

Referring to FIGS. 1 and 2, a Venetian blind 10 is shown comprising a headrail 11 fixedly transversely fastened to the top side of the window, the headrail 11 having a first end 12 (the right end) and an opening 13 in the bottom side of the first end 12, a bottom rail 14 extended in transverse direction and spaced below the headrail 11, a number of slats 15 arranged in parallel between the headrail 11 and the bottom rail 14, a lift lock 20 installed in the first end 12 of the headrail 11 above the opening 13, a hanger 30, a receiving tube 40, and two lift cords 50. The lift lock 20 is comprised of a transverse guide rod 21, an oblique rack 23, a movable ratchet wheel 22 meshed with the oblique rack 23, and a stop rod 24 extended over the opening 13 below the oblique rack 23 and adapted to limit downward movement of the movable ratchet wheel 22. When the movable ratchet wheel 22 moved upwards, the movable ratchet wheel 22 is engaged into the periphery of the lift cords 50 against the guide rod 21, and therefore the lift cords 50 are locked. On the contrary, when the movable ratchet wheel 22 moved downwards, the lift cords 50 are unlocked.

The hanger 30 is made of a rigid wire rod, having a hanging portion 31 and a track portion 32. The two distal ends of the wire rod are bent into a respective hooked portion 311, forming the hanging portion 31. The hanging portion 31 is hung on the stop rod 24 of the lift lock 20. The track portion 32 is comprised of straight rail 321 formed of a middle part of the wire rod between the hooked portions 311 of the hanging portion 31.

The receiving tube 40 is a straight round tube having a top open end and a bottom close end. The top open end of the receiving tube 40 is provided with a swinging ring 41, which is hung on the straight rail 321 of the track portion 32 for deflection. Therefore, the receiving tube 40 can be swung back and fro and rotated relative to the headrail 11. Further, the receiving tube 40 defines a longitudinal receiving space 42.

The lift cords 50 have a respective first end symmetrically fixedly fastened to the bottom rail 14, and a respective second end upwardly inserted through a respective through hole (not shown) in each slat 15 and then inserted into the inside of the headrail 11 and then extended in the same direction toward the first end 12 of the headrail 11 and then extended over the transverse guide rod 21 of the lift lock 20 and then turned downwards through the gap between the transverse guide rod 21 and the movable ratchet wheel 22 to the outside of the headrail 11 via the opening 13 (the two lift cords 50 are separated by the stop rod 24 when passing through the opening 13). When extended out of the opening 13 of the headrail 11, the second ends of the lift cords 50 are inserted into the inside of the longitudinal receiving space 42 of the receiving tube 40 and then fastened to a pulling device, which can be a telescopic tube, spiral spring, etc. Because the pulling device is of the known art and not within the scope of the present invention, no further detailed description in this regard is necessary. Subject to the size of the Venetian blind, one or more lift cords can be installed in the Venetian blind.

The Venetian blind 10 further comprises a tilting control mechanism adapted for controlling the tilting angle of the slats. Because the tilting control mechanism is of the known art and not within the scope of the claims of the present invention, no further detailed description in this regard is necessary.

When the Venetian blind receives no external force, the lift lock 20 locks the lift cords 50. The gravity weight of the bottom rail 14 and the slats 15 pulls the lift cords 50 downwards (i.e., the lift cords 50 are pulled leftwards in the headrail 11), thereby causing the movable ratchet wheel 22 to be rotated upwards along the oblique rack 23 by the lift cords 50. When the movable ratchet wheel 22 rotated upwards along the oblique rack 23, it forces the lift cords 50 against the periphery of the guide rod 21, thereby causing the lift cords 50 to be jammed in between the movable ratchet wheel 22 and the guide rod 21 to hold the bottom rail 14 at a particular elevation.

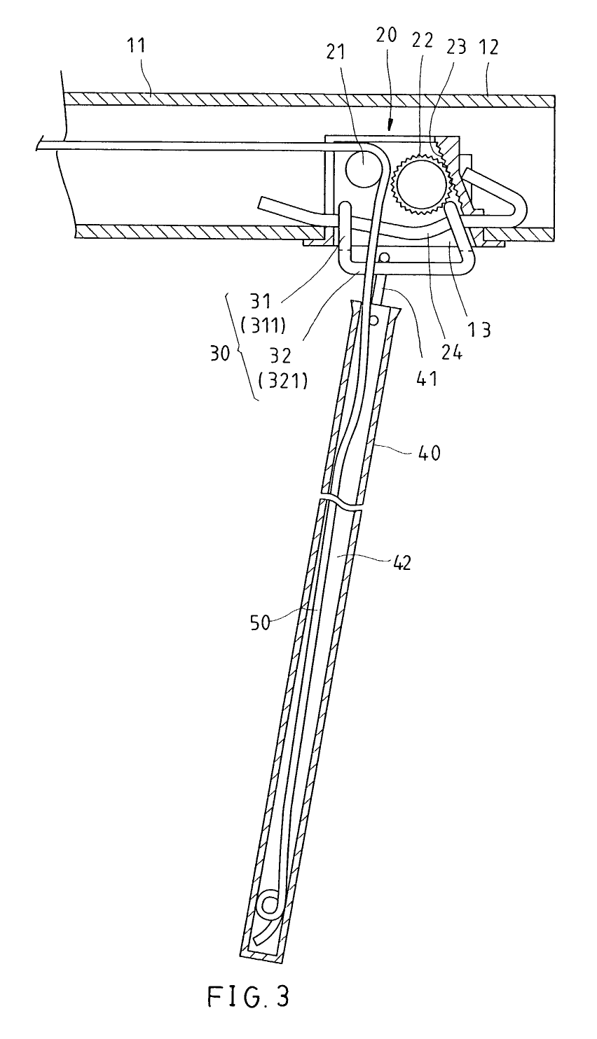

Referring to FIG. 3, when wishing to lift the blind, the user can bias the lift cords 50 leftwards. Because the swinging member 41 of the receiving tube 40 is hung on the track portion 32 of the hanger 30 and the hanging portion 31 of the swinging member 30 is hung on the stop rod 24, the receiving tube 40 is moved leftwards along the straight rail 321 of the track portion 32 to disengage the movable ratchet wheel 22 from the lift cords 50, for enabling the lift cords 50 to be moved back and forth relative to the lift lock 20 to adjust the elevation of the bottom rail 14.

When the bottom rail 14 adjusted to the desired elevation, the user can then pull the receiving tube 40 rightwards along the straight rail 321 of the track portion 32 and then release the lift cords 50. At this time, the gravity wait of the bottom rail 14 and the slats 15 impart a downward force to the first ends of the lift cords 50 and the lift cords 50 are partially obliquely disposed in contact with the bottom side of the movable ratchet wheel 22. Therefore, when the lift cords 50 received a pulling force from the first ends, the movable ratchet wheel 22 is immediately forced to rotate in clockwise direction along the rack 23 toward the left upper end, thereby causing the lift cords 50 to be jammed in between the movable ratchet wheel 23 and the guide rod 21, i.e., the bottom rail 14 is positively maintained at the elevation when released the lift cords 50.

As indicated above, the receiving tube 40 is coupled to the headrail 11 by the hanger 30. The receiving tube 40 can be turned back and forth relative to the headrail 11 within an angle to control locking/unlocking of the lift cords 50. Further, because the hooked portions 311 of the hanging portion 31 of the hanger 30 are hooked on the stop rod 24 of the lift lock 20 and the swinging ring 41 of the receiving tube 40 is hung on the straight rail 321 of the track portion 32 of the hanger 30, the receiving tube 40 can be moved horizontally forwards/backwards relative to the headrail 11 within the distance between the hooked portions 311 of the hanging portion 31 of the hanger 30 and then turned leftwards/rightwards to lock/unlock the lift cords 50, for enabling the bottom rail 14 (and the slats 15) to be adjusted to the desired elevation. Because of orthopedically engineered, the user can operate the Venetian blind with less effort.

It is to be understood that the structure and action of the aforesaid lift lock 20 is of the known art. Various lift lock designs (the arrangement of a guide rod and an eccentrically pivoted ratchet wheel) are known and can be selectively used to substitute for the aforesaid lift lock 20.

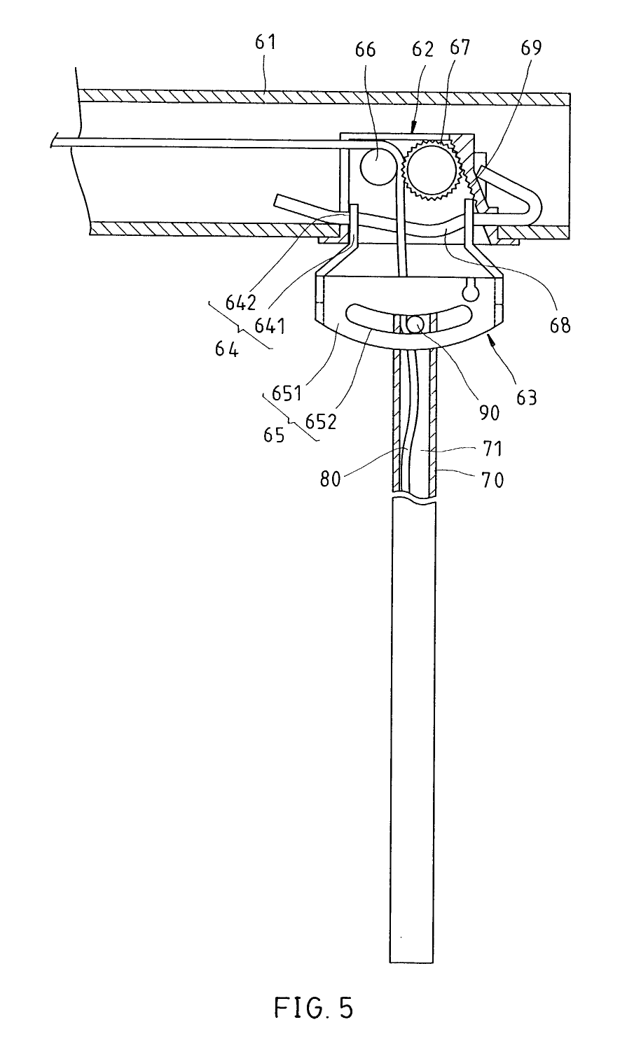

FIGS. 5˜7 show a Venetian blind according to the second preferred embodiment of the present invention. According to this embodiment, the lift Venetian blind comprises:

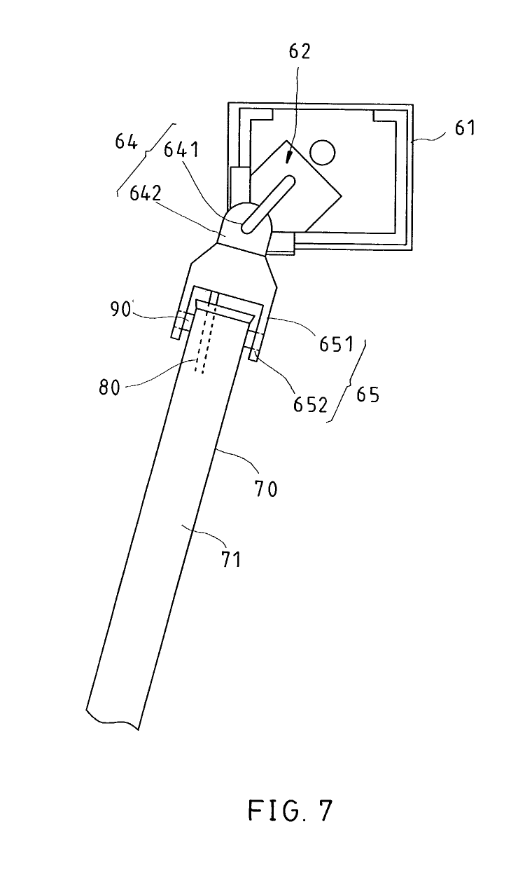

a headrail 61 (FIG. 7 shows only the first end of the headrail);

a bottom rail (not shown) spaced below the headrail 61;

a set of slats (not shown) arranged in parallel between the headrail 61 and the bottom rail;

a lift lock 62 mounted in the first end of the headrail 61, the lift lock 62 comprising a fixed guide rod 66, an oblique rack 69, a movable ratchet wheel 67 meshed with and moved along the oblique rack 69, and a stop rod 68 provided below the oblique rack 69 and adapted to limit downward movement of the movable ratchet wheel 67;

a swinging device 63, the swinging device 63 comprising a hanging portion 64 and a track portion 65, the hanging portion 64 comprising two top lugs 644 bilaterally upwardly extended from the track portion 65, each top lug 644 having a pivot hole 642 respectively coupled to the stop rod 68 of the lift lock 62, the track portion 65 comprising two downward lugs 651 arranged in parallel, each downward lug 651 having a substantially horizontally extended and smoothly arched sliding slot 652;

a receiving tube 70, the receiving tube 70 being a straight round tube having a top open end pivotally connected between the two sliding slots 652 of the swinging device 63 by a pivot pin 90, and a longitudinal receiving space 71; and

two lift cords 80, the lift cords 80 each having a first end fixedly fastened to the bottom rail, and a second end inserted through the slats into the inside of the headrail and then extended sideways to the first end of the headrail and then turned downwards through the gap between the fixed guide rod 66 and the movable ratchet wheel 67 and extended downwards to the inside of the longitudinal receiving space 71 of the receiving tube 70.

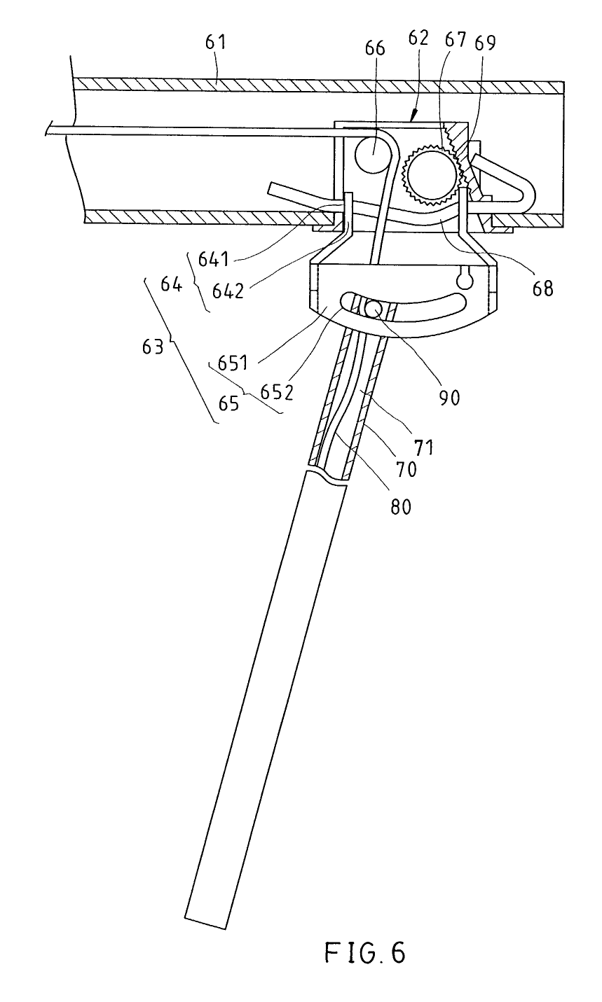

The operation of this second embodiment is similar to the aforesaid first embodiment. Because the receiving tube is coupled to the headrail by the swinging device, the receiving tube can be moved along the sliding slots of the swinging device and then turned leftwards/rightwards to lock/unlock the lift cords (see FIGS. 6 and 7).

What the invention claimed is:

1. A Venetian blind comprising:
a headrail extended in transverse direction, said headrail having a first end;
a bottom rail extended in transverse direction and spaced below said headrail;
a plurality of slats arranged in parallel between said headrail and said bottom rail;
a receiving tube vertically suspended from the first end of said headrail;
at least one lift cord, said at least one lift cord each having a first end fixedly fastened to said bottom rail and a second end upwardly extended through said slats into the inside of said headrail and then transversely extended to the first end of said headrail and then extended vertically downwards from the first end of said headrail into the inside of said receiving tube; and
a lift lock mounted inside the first end of said headrail and controlled by said receiving tube to lock/unlock said lift cords;
wherein a swinging device is coupled between said lift lock and said receiving tube for enabling said receiving tube to be turned back and forth in a predetermined direction relative to said headrail, said swinging device comprising a hanging portion coupled to said headrail, and a track portion pivoted to said receiving tube for enabling said receiving tube to be moved along said bottom track portion.

2. The Venetian blind as claimed in claim 1, wherein the hanging portion of said swinging device is pivoted to a part of said lift lock for enabling said receiving tube to be turned forwards/backwards relative to said headrail in a first direction; said receiving tube has a top open end pivoted to the track portion of said swinging device for turning leftwards/rightwards relative to said headrail in a section direction perpendicular to said first direction.

3. The Venetian blind as claimed in claim 2, wherein said lift lock comprises a fixed guide rod adapted for guiding said at least one lift cord toward said receiving tube, a fixed oblique rack spaced from said fixed guide rod at one side, a movable ratchet wheel meshed with said oblique rack and moved along said oblique rack between two ends of said oblique rack to lock/unlock said at least one lift cord, and a stop rod suspended below said movable ratchet wheel and said fixed guide rod and adapted to limit downward movement of said movable ratchet wheel; said hanging portion of said swinging device is hung on said stop rod of said lift lock.

4. The Venetian blind as claimed in claim 3, wherein said hanging portion of said swinging device is comprised of a hooked portions arranged in parallel and respectively hung on said stop rod of said lift lock.

5. The Venetian blind as claimed in claim 3, wherein said hanging portion of said swinging device comprises at least one pivot hole pivoted to said stop rod of said lift lock.

6. The Venetian blind as claimed in claim 1, wherein said receiving tube has a swinging ring pivoted to a top open end thereof and coupled to said track portion of said swinging device; said track portion of said swinging device comprises a straight rail inserted the swinging ring of said receiving tube for enabling said receiving tube to be moved long said straight rail and turned relative to said headrail.

7. The Venetian blind as claimed in claim 1, wherein said track portion of said swinging device comprises at least one smoothly arched sliding slot; said receiving tube has a top open end pivoted to the at least one smoothly arched sliding slot of said track portion of said swinging device.

8. The Venetian blind as claimed in claim 7, wherein the top open end of said receiving tube is pivoted to the at least one smoothly arched sliding slot of said track portion of said swinging device by a pivot pin, which is movable with said receiving tube along the at least one smoothly arched sliding slot of said track portion of said swinging device.

9. The Venetian blind as claimed in claim 1, wherein said receiving tube defines a longitudinal receiving space adapted to receive the second end of each of said at least one lift cord and to keep said at least one lift cord from sight.
